(19) United States
(12) Patent Application Publication
(10) Pub. No.: US 2012/0132043 A1
(43) Pub. Date: May 31, 2012

(54) RATCHETING MECHANICAL TORQUE WRENCH WITH AN ELECTRONIC SENSOR AND DISPLAY DEVICE

(76) Inventors: Xia Chen, Clarksville, MD (US); Muniswamappa Anjanappa, Ellicott City, MD (US)

(21) Appl. No.: 13/187,663

(22) Filed: Jul. 21, 2011

Related U.S. Application Data
(60) Provisional application No. 61/417,930, filed on Nov. 30, 2010.

(51) Int. Cl. B25B 23/144

(52) U.S. Cl. 81/479

(57) ABSTRACT

A mechanical torque wrench for engaging a workpiece, including a wrench body, a wrench head with a workpiece engaging portion and a bar, the wrench head being pivotably secured to the wrench body, a set spring, a pawl disposed between the bar and the set spring, and a dial screw, wherein rotation of the dial screw in a first direction compresses the set spring. A resistive element is coupled to the dial screw and produces an output signal. A first sensor produces a first output signal that is proportional to an amount of rotation of the mechanical torque wrench. A processor converts the resistive element output signal into an equivalent torque value indicating a preset torque to be applied by and converts the first output signal into a first angle value. A user interface includes a display for displaying the equivalent torque value. The application of a torque greater than the preset torque causes the wrench head to pivot relative to the wrench body.

### CLAIM OF PRIORITY

This application claims priority to U.S. Provisional Patent Application No. 61/417,930 filed Nov. 30, 2010, the entire disclosure of which is incorporated by reference herein.

### FIELD OF THE INVENTION

The present invention relates generally to mechanical torque wrenches. More particularly, the present invention relates to a ratcheting mechanical clicker type torque wrench and a sensor for determining an amount of angular rotation of the torque wrench.

### BACKGROUND OF THE INVENTION

Often, fasteners used to assemble performance critical components are tightened to a specified torque level to introduce a “pretension” in the fastener. As torque is applied to the head of the fastener, the fastener may begin to stretch beyond a certain level of applied torque. The stretching results in pretension in the fastener which then holds the joint together. Additionally, it is often necessary to further rotate the fastener through a specified angle after the desired torque level is applied. Over-stressing fasteners can lead to their failure whereas under-stressing can lead to joint failure, leakage, etc. Furthermore, in situations where gaskets are being utilized between the components being joined, an unequally stressed set of fasteners can result in gasket distortion and subsequent problems like leakage. Accurate and reliable torque wrenches help insure that fasteners are tightened to the proper specifications.

Torque wrenches may be of the mechanical or electronic type. Mechanical torque wrenches are generally less expensive than electronic. There are several types of mechanical torque wrenches that are routinely used to tighten fasteners to specified torque levels. Of these, clicker type mechanical torque wrenches are very popular. Clicker type mechanical torque wrenches make an audible click to let the user know when a preset torque level has been achieved and simultaneously provide a feeling of sudden torque release to the user.

One example of a clicker type torque wrench includes a hollow tube in which a spring and block mechanism is housed. The block is forced against one end of a bar that extends from a drive head. The bar and drive head are pinned to the hollow tube about a pivot joint and rotate relative thereto once the preset torque level is exceeded. The preset torque level is selected by a user by causing the spring to exert either greater or lesser force on the block. The force acts on the bar through the block to resist the bar's rotation relative to the hollow tube. As the torque exerted on the fastener exceeds the preset torque value, the force tending to cause the bar to pivot relative to the hollow tube exceeds the force exerted by the block that prevents the bar's rotation, and the block “trips.” When released by the block's action, the bar pivots and hits the inside of the tube, thereby producing a click sound and a sudden torque release that is detectable by the user.

Another example of a clicker type torque wrench measures the deflection of a deflectable beam relative to a non-deflectable beam, the deflectable beam causing a click once the preset torque is reached. These and other types of clicker type mechanical torque wrenches are popular since they are relatively easy to operate and make torquing relatively quick and simple. The user merely sets the desired torque value and pulls on the handle until he hears and feels the click and torque release, indicating that the desired torque value has been reached.

One drawback that limits the usage of many mechanical type torque wrenches is the inability to measure the angular rotation of the fastener. Typically, mechanical torque wrenches lack this ability because they do not include a power source and, therefore, cannot support the use of the required sensor, such as a gyroscopic sensor. As such, for fasteners where it is necessary to rotate the fastener through a specified angle after the desired torque level is applied with the mechanical torque wrench, an electronic torque wrench with the ability to measure angular rotation is often required to complete tightening the fastener.

Some electronic torque wrenches (ETWs) are capable of measuring angular rotation of the wrench, and therefore the fastener, in addition to measuring the amount of torque applied to the fastener. As such, for those fasteners that require further rotation after the initial application of the desired torque value, an electronic torque wrench may be desirable since only one torque wrench is required. However, fasteners are often positioned such that both the torque and the desired additional angular rotation may not be applied with the torque wrench in a single, continuous motion. In such cases, an electronic torque wrench having a ratcheting feature can be used.

The present invention recognizes and addresses certain or all the foregoing considerations, and others, of prior art constructions.

### SUMMARY OF THE INVENTION

One embodiment of the present invention provides a mechanical torque wrench with a wrench body defining an elongated interior compartment, a wrench head including a workpiece engaging portion and a bar extending therefrom, the wrench head being pivotably secured to a first end of the wrench body at a pivot joint, the bar extending into the interior compartment and the workpiece engaging portion extending outwardly from the wrench body. A set spring is disposed within the interior compartment of the wrench body, a block is disposed between a rear face of the bar and the set spring, and a dial screw is threadably received within the interior compartment of the wrench body such that the dial screw moves along a longitudinal axis of the wrench body when rotated, rotation of the dial screw in a first direction compressing the set spring and rotation in a second direction allowing expansion of the set spring. A resistive element is operatively coupled to the dial screw and produces an output signal, the output signal being dependent on a position of the dial screw relative to the resistive element. A first sensor is operatively coupled to the wrench body and produces a first output signal, the first output signal being proportional to an amount of rotation being applied to the workpiece by the torque wrench during a first rotational cycle of the mechanical torque wrench. A processor converts the output signal into an equivalent torque value, the equivalent torque value indicating a preset torque to be applied by the mechanical torque wrench to the workpiece, and converting the first output signal into a first angle value through which the workpiece has been rotated. A user interface includes a display for displaying the equivalent torque value. The application of a torque greater than the preset torque to the workpiece causes the wrench head to pivot relative to the wrench body about the pivot joint.

Another embodiment of the present invention provides a mechanical torque wrench with a wrench body defining an elongated interior compartment, a wrench head pivotably received in the interior compartment, the wrench head including a drive portion for engaging the workpiece and a bar extending into the interior compartment. A set spring is disposed within the interior compartment of the wrench body, a dial screw is rotatably received within the interior compartment of the wrench body, rotation of the dial screw in a first direction increasing force exerted on the set spring and rotation of the dial screw in a second direction decreasing force exerted on the set spring by the dial screw. A gyroscopic sensor is operatively coupled to the wrench body and produces a first output signal, the first output signal being proportional to an amount of rotation being applied to the workpiece by the torque wrench. A processor converts the first output signal into a first angle value through which the workpiece has been rotated during a first rotational cycle of the torque wrench. A user interface includes a display for displaying the first angle value. The application of a torque greater than a preset torque value to the workpiece causes the wrench head to pivot relative to the wrench body about the pivot joint

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a top view of a mechanical clicker type torque wrench with an electronics unit in accordance with an embodiment of the present invention;

FIG. 2 is an exploded perspective view of the mechanical torque wrench as shown in FIG. 1;

FIG. 3 is a perspective view of a resistive element assembly of the mechanical torque wrench as shown in FIG. 1;

FIG. 4 is an exploded perspective view of the resistive element assembly of the mechanical torque wrench as shown in FIG. 1;

FIG. 5 is a partial cut-away top view of the mechanical torque wrench as shown in FIG. 1;

FIGS. 6A and 6B are partial cross-sectional views of the mechanical torque wrench as shown in FIG. 1, revealing the embodiment of the resistive element assembly shown in FIG. 3;

FIGS. 7A and 7B are partial cross-sectional views of the mechanical torque wrench as shown in FIG. 1, revealing an alternate embodiment of a resistive element assembly;

FIG. 8 is a partial electrical circuit of the electronics unit of the mechanical torque wrench as shown in FIG. 1;

FIG. 9 is a block diagram representation of the electronics unit of the mechanical torque wrench as shown is FIG. 1;

FIG. 10 is a block diagram representation of electronics unit of the mechanical torque wrench as shown in FIG. 1;

FIG. 11 is a flow chart of the algorithm utilized by the mechanical torque wrench as shown in FIG. 1 to measure accumulated angular rotation of the wrench;

FIGS. 12A, 12B and 12C are views of a display device as used with the mechanical torque wrench shown in FIG. 1; and

FIG. 13 is a flow chart of the display algorithm of the display device as shown in FIGS. 12A, 12B and 12C.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

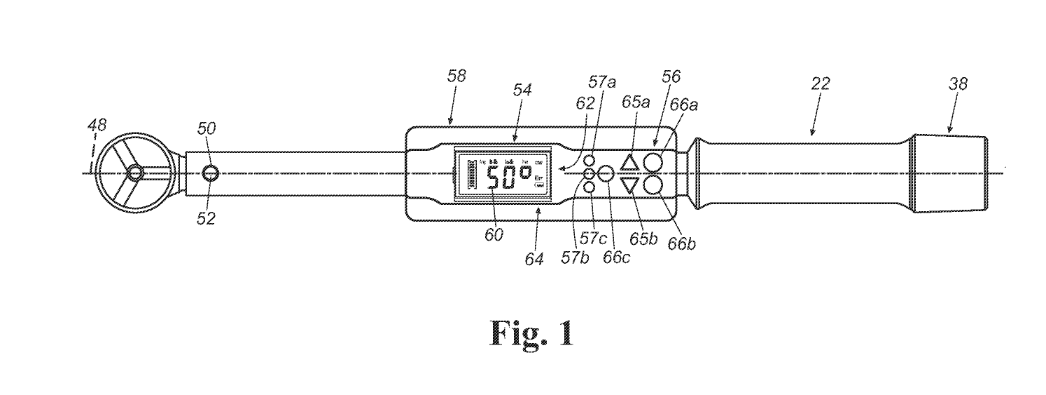

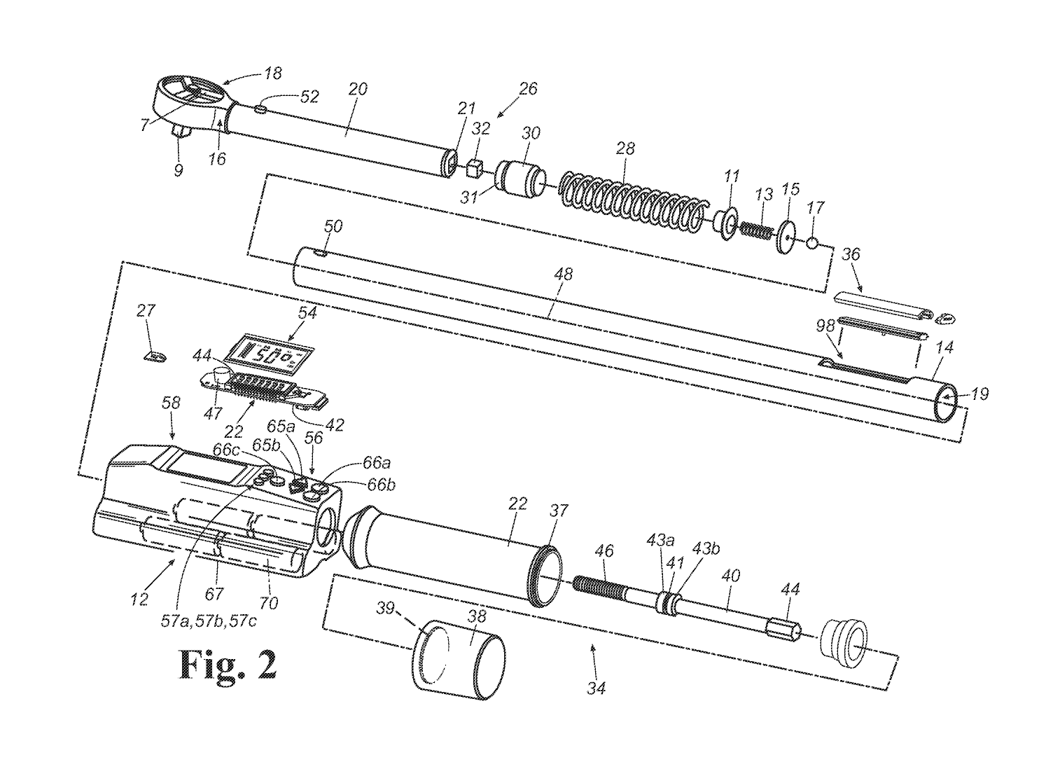

Referring now to FIGS. 1 and 2, a preferred embodiment of a mechanical clicker type torque wrench 10 includes an electronics unit 12, an elongated wrench body 14, a wrench head 16 including a ratcheting mechanism 18 and a bar 20 extending therefrom, and a hand grip 20 attached to one end of wrench body 14. As shown, ratcheting mechanism 18 of wrench head 16 includes a lever device 7 that allows a user to select whether torque is applied to a fastener in either a clockwise (CW) or counter-clockwise (CCW) direction. The ratcheting mechanism 18 includes a boss 9 for receiving variously sized sockets, extensions, etc.

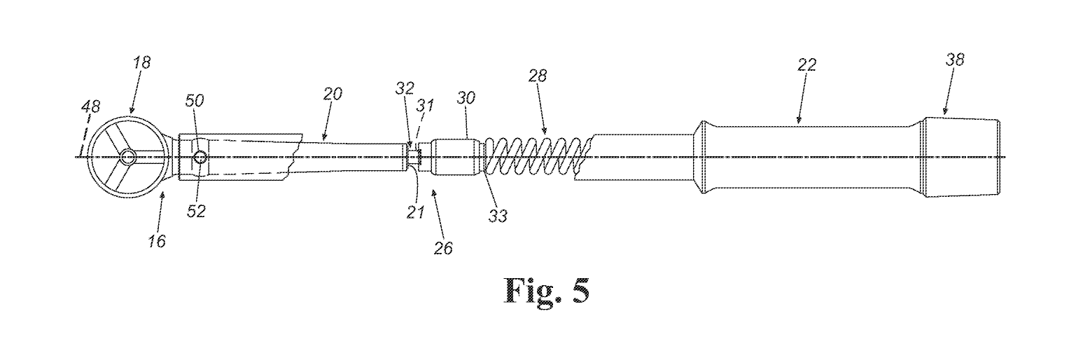

Electronics unit 12, including a user interface, is received on wrench body 14 between the hand grip and wrench head 16. An interior compartment 19 of wrench body 14 houses a clicker mechanism 26 that includes a set spring 28, a plug assembly 30, a block 32, and slender bar 20, as best seen in FIG. 5. The block is sandwiched between the slender bar and the spring. Additionally, a gyroscopic sensor 27 is mounted in mechanical torque wrench 10 on the printed circuit board 42. Gyroscopic sensor 27 is preferably a MEMS gyroscopic sensor, such as Model No. XV3500 manufactured by EPSON, Tokyo, Japan. However, other sensors that are capable of angular measurement may also be used.

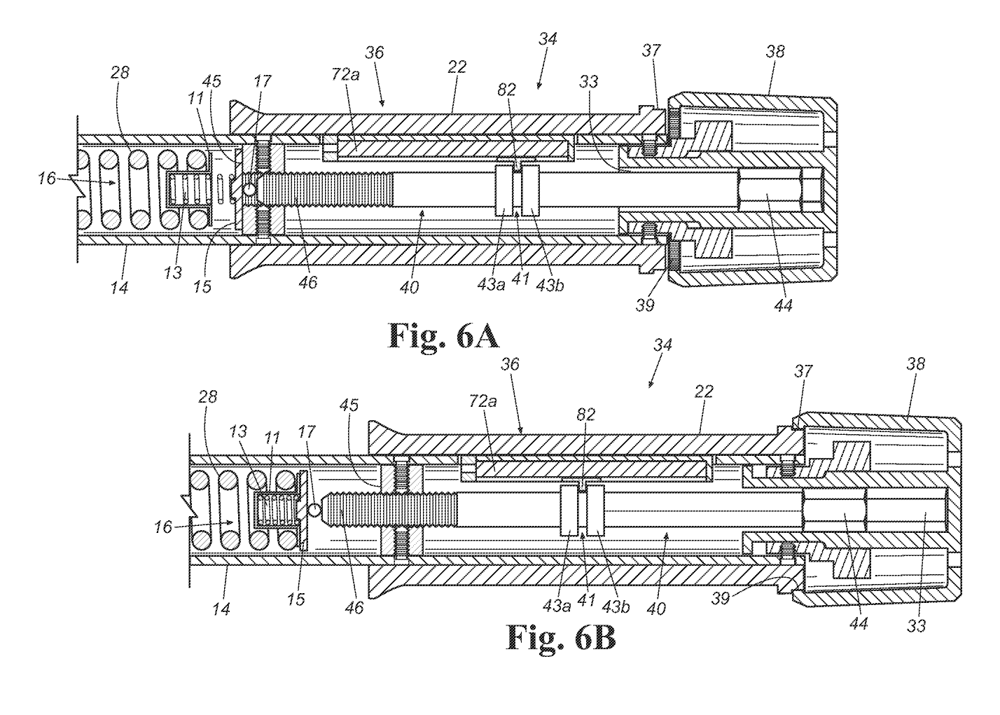

An adjustment assembly 34 is disposed on wrench body 14 opposite wrench head 16 for selectively adjusting a resistive element assembly 36 mounted to wrench body 14. Adjustment assembly 34 includes an end cap 38, a dial screw 40, and a nut 45 (FIG. 6A) fixed in interior compartment 19 of wrench body 14. End cap 38 engages a first end 44 of dial screw 40 and is selectively rotatable relative to wrench body 14. A second end 46 of dial screw is threaded and engages nut 45 such that rotation of dial screw 40 causes it to move axially along a longitudinal center axis 48 of wrench body 14. A spring cap 11 is received in the back end of set spring 28 and receives an engagement spring 13 therein. A thrust washer 15 abuts the rear end of engagement spring 13 and exerts force from dial screw 40 on set spring 28 via contact with spring cap 11 when the engagement spring is fully compressed therein, as discussed in greater detail below. A ball cam 17 is positioned between a front face of dial screw 40 and thrust washer 15.

Wrench head 16 is pivotably secured to a first end of wrench body 14 such that bar 20 extends into interior compartment 19 and ratcheting mechanism 18 protrudes outwardly from wrench body 14. Wrench head 16 is secured to wrench body at pivot joint 50 that includes a pivot pin 52 that is both perpendicular to longitudinal center axis 48 of wrench body 14 and transverse to a plane defined by torque wrench 10 as it is rotated about a workpiece during torquing operations. As shown, wrench head 16 includes ratchet mechanism 18 so that torque may be selectively applied to a workpiece (not shown) in either the clockwise or counterclockwise direction. However, alternate embodiments need not include a ratcheting mechanism.

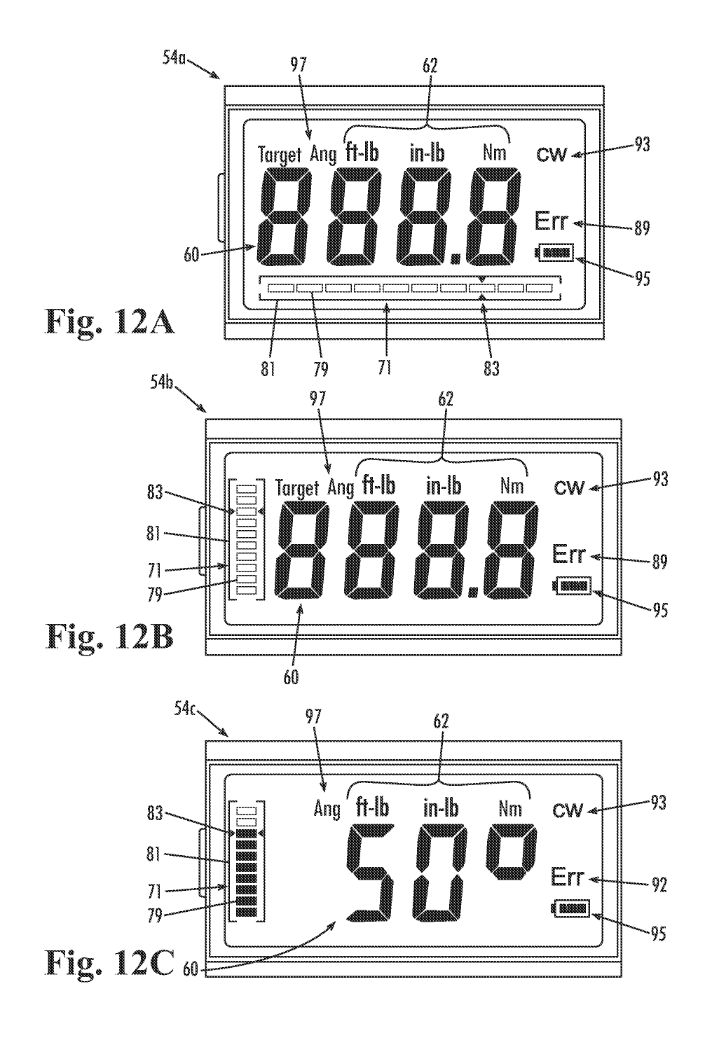

Electronics unit 12 includes a user interface including a visual display 54, preferably a liquid crystal display, and a user input device 56 that includes a bank of buttons. Visual display 54 and input device 56 are both supported on printed circuit board 42 which is in turn supported by a housing 58, preferably formed of injection molded plastic. Printed circuit board 42 additionally carries a microcontroller and any additional electronic components for operation of the electronics unit. Visual display 54 includes a numerical display 60 (FIGS. 12A through 12C) to assist a user in setting a preset torque for the torque wrench, a torque unit indicator 62 that displays the units of the preset torque, and a battery level indicator 95 for displaying the condition of the batteries. As shown, input device 56 includes a power button 66a, a unit selector button 66b for choosing the units to be shown on visual display 54, an angle mode selector button 66c for entering the angle measurement mode of the wrench and increment/decrement buttons 65a and 65b for selecting a target angle, as discussed in greater detail below. Further, the housing of electronics unit 12 has a flat bottom surface 67 that forms a stable platform for setting the torque wrench down when it is not in use. The housing also defines a battery compartment 70 that is external to interior compartment of wrench body 14.

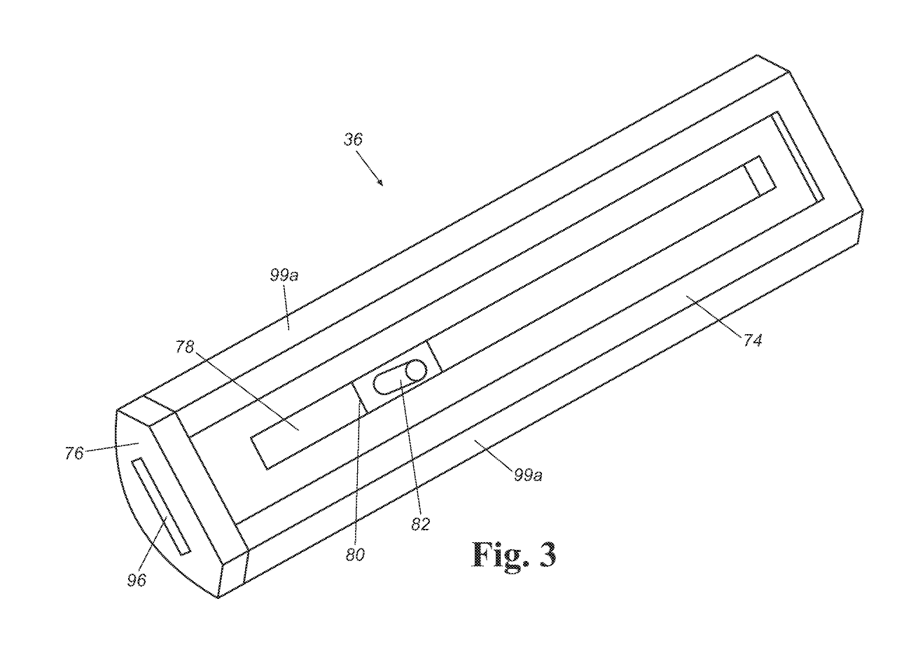

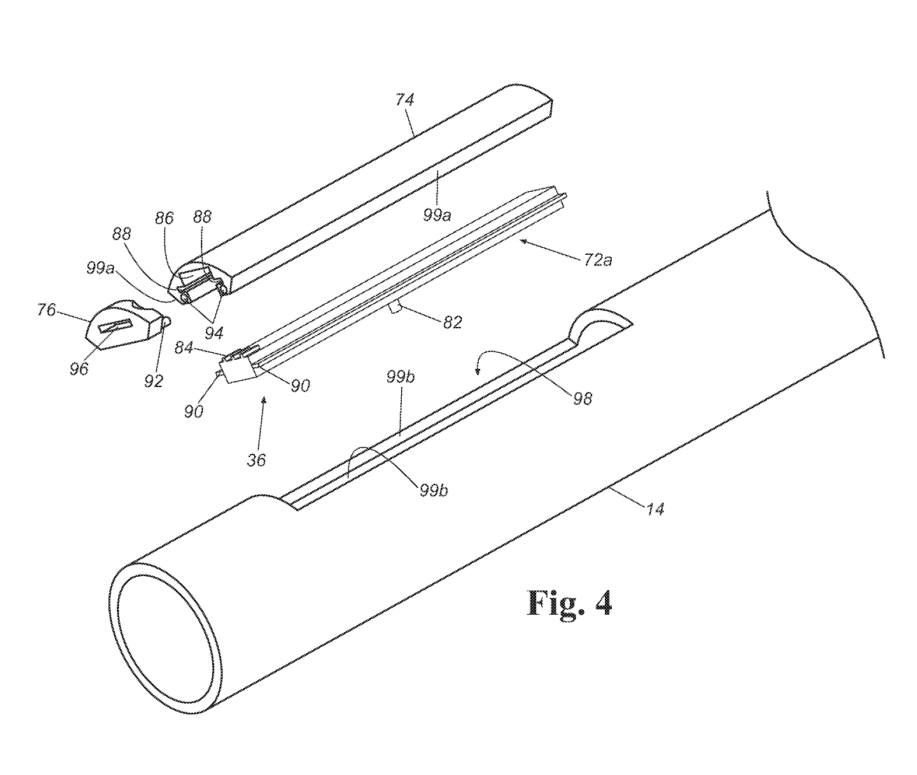

Referring now to FIGS. 3 and 4, resistive element assembly 36 includes a resistive element 72a, e.g., a potentiometer, a housing 74 and an end cap 76. As shown, the resistive element is a sliding potentiometer that includes a linear resistor 78, a wiper assembly 80 configured for motion along linear resistor 78, an adjustment pin 82 extending outwardly from wiper assembly 80 and terminal leads 84 for receiving wires from electronics unit 12. Motion of wiper assembly 80 along linear resistor 78 causes the overall resistance of sliding potentiometer 72a to vary, as discussed in greater detail below. Sliding potentiometer 72a is slidably received in a central recess 86 of housing 74. Axial recesses 88 extending outwardly from central recess 86 slidably receive axial guides 90 that extend outwardly from sliding potentiometer 72a to insure proper positioning of the potentiometer within housing 74. After linear potentiometer 72a is positioned in housing 74, end cap 76 is secured to housing 74 by inserting mounting pins 92 extending from end cap 76 into pin apertures 94 formed on housing 74 in a press-fit. End cap 76 includes a lead aperture 96 that allows wires from electronics unit 12 to pass therethrough so they may be connected to terminal leads 84 on sliding potentiometer 72a. Once assembled, resistive element assembly 36 is mounted in an aperture 98 defined by wrench body 14. Housing 74 and aperture 98 include corresponding pairs of axially extending abutment surfaces 99a and 99b, respectively, such that when housing 74 is mounted in aperture 98, the outer surfaces of housing 74 and wrench body 14 provide a smooth cylindrical surface.

As best seen in FIG. 5, block 32 of clicker mechanism 26 is substantially cube-shaped and is disposed between a rear face 21 of bar 20 and a forward face 31 of plug assembly 30. Forward face 31 of the plug assembly includes a recess 31 that is shaped correspondingly to the outer surface of block 32 which rests against it. Recessed forward face 31 insures that the vertical longitudinal center axis of block 32 remains perpendicular to a plane defined by longitudinal center axis 48 as torque wrench 10 is rotated. As such, block 32 functions properly when the preset torque value is reached, as discussed in greater detail below. A rearward face 33 of plug assembly 30 receives the front end of set spring 28. Plug assembly 30 has an outer surface dimensioned sufficiently close to the inner diameter of body 14 (i.e. interior compartment 19) so that although the plug assembly is slidably received within interior compartment 19 of wrench body 14, it is limited to minimal transverse motion relative to wrench body 14.

Referring now to FIGS. 6A and 6B, end cap 38 of adjustment assembly 34 is selectively rotatable relative to hand grip 22, and therefore wrench body 14. End cap 38 includes an annular array of locking teeth 39 formed about its forward inner perimeter that are selectively engageable with an annular array of locking teeth 37 formed about the rear outer periphery of hand grip 22. In a forward position (FIG. 6B) relative to hand grip 22, locking teeth 39 on end cap 38 engage locking teeth 37 on hand grip 22, thereby rotationally fixing end cap 38 to wrench body 14. In a rearward position (FIG. 6A), locking teeth 39 to end cap 38 are disengaged from locking teeth 37 on hand grip 22 and end cap 38 is therefore rotatable relative to wrench body 14.

End cap 38 includes an axial bore 33 that is configured to slidably receive first end 44 of dial screw 40. As shown, an outer surface of dial screw first end 44 and an inner surface of axial bore 33 define corresponding hexagonal cross-sectional shapes such that end cap 38 is non-rotatable relative to dial screw 40. Second end 46 of dial screw 40 is threaded and received by correspondingly threaded nut 45 that is rotationally fixed inside inner compartment 19 of wrench body 14. As such, rotation of end cap 38, and therefore dial screw 40, relative to wrench body 14 causes dial screw 40 to translate axially along longitudinal center axis 48 of wrench body 14. The direction of axial motion is dependent on the direction of rotation of end cap 38 and causes dial screw 40 to either increase or decrease the torque value at which block 32 trips.

As best seen in FIG. 6A, when dial screw 40 is in the fully retracted position, thrust washer 15 abuts threaded nut 45, and engagement spring 13 exerts a forward biasing force on set spring 28 through spring cap 11. This forward biasing force insures that block 32 remains properly positioned between the forward face of plug assembly 31 and the rear face of slender bar 20 (FIG. 5) when dial screw 40 is fully retracted. To preset a torque value from the fully retracted position, end cap 38 is rotated in a clockwise direction such that dial screw 40 moves forward against set spring 28. In so doing, dial screw 40 urges thrust washer 15 forwardly until the thrust washer abuts spring cap 11 and engagement spring 13 is fully compressed therein. Continued rotation of end cap 38 causes thrust washer 15 to exert an increasing amount of force on set spring 28, thereby causing the amount of torque required to “trip” the torque wrench to similarly increase.

As shown, an annular groove 41 is formed about a central portion of dial screw 40 by a pair of radially outwardly extending shoulders 43a and 43b. Annular groove 41 is configured such that its fore and aft dimensions are substantially the same as the fore and aft dimensions of adjustment pin 82 of sliding potentiometer 72a. Annular groove 41 is configured to slidably receive adjustment pin 82 of sliding potentiometer 72a such that, as dial screw 40 is rotated in either direction and is translated along longitudinal center axis 48 of wrench body 14, adjustment pin 82 is engaged and moved by either radial shoulder 43a or 43b, depending upon the direction of axial motion of dial screw 40, so that the overall resistance provided by the sliding potentiometer is altered. Annular groove 41 is dimensioned and configured such that minimal friction is encountered as radial shoulders 43a and 43b are rotated relative to adjustment pin 82, and adjustment pin 82 is configured to have a smooth cylindrical outer surface. As well, adjustment pin 82 is received in annular groove 41 so as to minimize unwanted vibrations that can possibly be transferred to the sliding potentiometer during use. Vibrations are also reduced since dial screw 40 is threadedly received by nut 45, and thereby immobilized with respect to the wrench body. These features help to maintain a stable display of the preset torque value on the display. Alternate embodiments of dial screw 40 may include an annular groove that extends radially inwardly into the body of dial screw 40 rather than being formed by a pair of radial solders 43a and 43b, as shown.

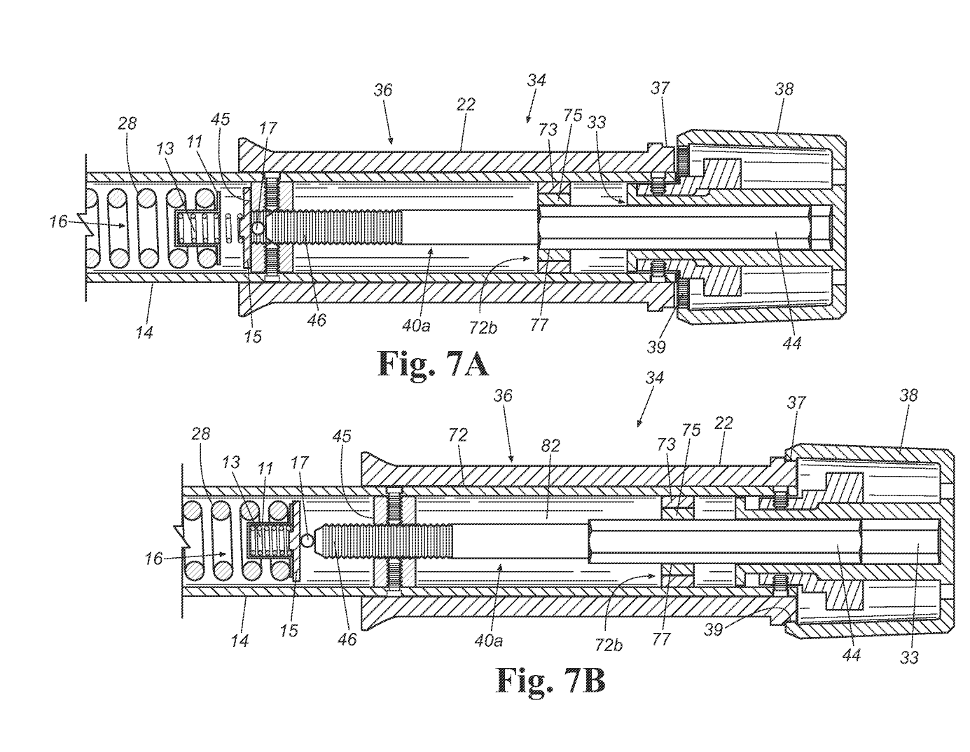

Referring now to FIGS. 7A and 7B, an alternate embodiment of a resistive element and dial screw is shown. The resistive element is an annular potentiometer 72b including an outer ring 73 that is rotationally fixed to inner compartment 19 of wrench body 14, an inner ring 75 that is rotatably secured to outer ring 73, and a central aperture 77 that is defined by inner ring 75 and configured to slidably receive a portion of dial screw 40a. As in the previously discussed embodiment, dial screw 40a includes a first end 44 having a cross-sectional shape that is complimentary to that of internal bore 33 of end cap 38, and second end 46 that is threadedly received in nut 45 that is non-rotatably secured to interior compartment 19 of wrench body 14. However, rather than the previously discussed annular groove and adjustment pin arrangement, dial screw 40a has an extended hexagonally shaped first portion 44 that extends along the length of dial screw 40a such that it is received in the correspondingly shaped central aperture 77 of inner ring 75 of the annular potentiometer. As such, as end cap 38 is rotated relative to hand grip 22, thereby causing axial motion of dial screw 40a along longitudinal center axis 48 of wrench body 14, inner ring 75 of the annular potentiometer rotates relative to outer ring 73. Outer ring 73 includes a resistive element and inner ring 75 includes a wiper assembly. Rotation of inner ring 75 relative to outer ring 73 causes the overall resistance of annular potentiometer 72b to change, as previously discussed with respect to the sliding potentiometer.

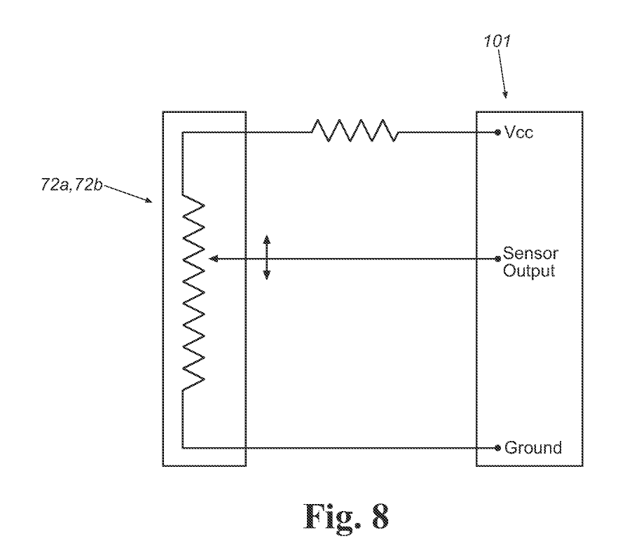

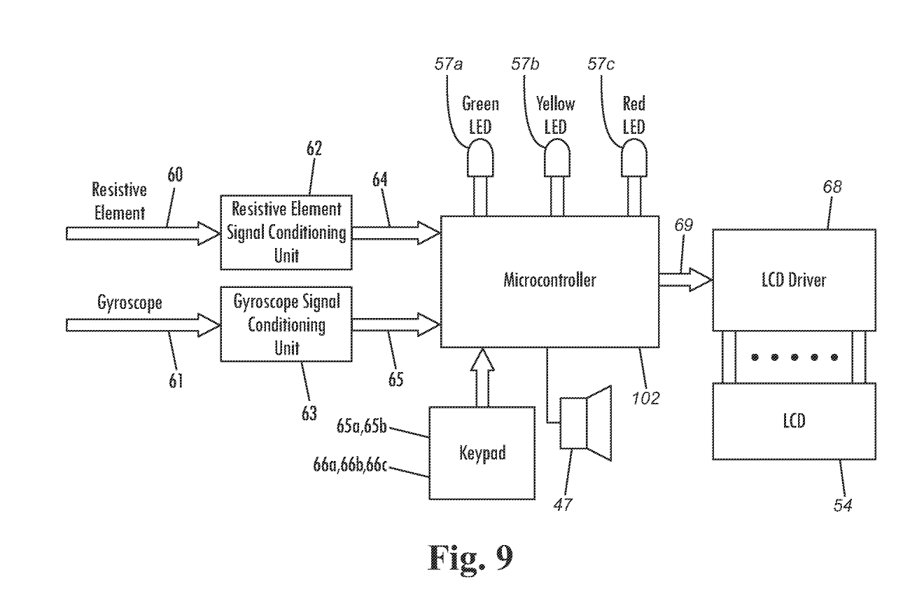

FIG. 8 illustrates a sensor electrical circuit 101 that determines the selected resistance of either sliding potentiometer 72a or annular potentiometer 72b in order to create an electrical signal for use by microcontroller 102. Sensor electrical circuit 101 utilizes a fixed DC excitation voltage (Vcc) in the range of 3 to 5 volts. Referring additionally to FIG. 9, sensor electrical circuit 101 sends an analog electrical signal 60 that varies in voltage proportionally to the resistance of the potentiometer to a resistive element signal conditioning unit 62 that amplifies the signal and filters it to remove noise from the signal. As the adjustment assembly dial screw rotates, the potentiometer's resistance changes as the position of the wiper assembly along the resister changes, which in turn changes the sensor electrical output circuit's output voltage. Because the output voltage is proportional to the resistance of the potentiometer, it is also proportional to the desired preset torque value being selected by the user.

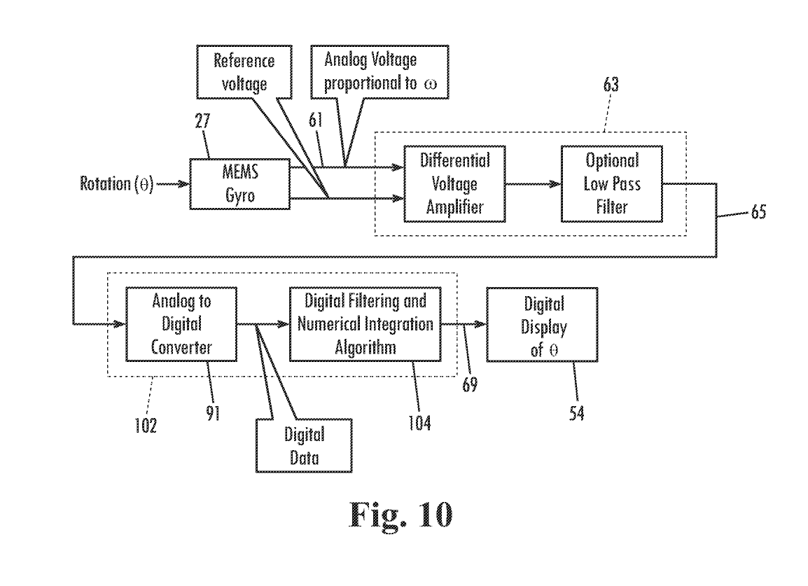

FIG. 9 illustrates a functional block diagram of the electronics unit of a torque wrench in accordance with one embodiment of the present invention. The analog electrical signal 64 from sensor electrical circuit 101 is converted to an equivalent digital value by an analog to digital converter 91 (FIG. 10) and is then fed to a microcontroller 102. A control algorithm 104 (FIG. 10) residing in microcontroller 102 converts the equivalent digital value into an equivalent preset torque value. A conversion table may be stored in memory accessible by microcontroller 102 for this purpose. A unit conversion algorithm converts the preset torque value to the units (inch-pound, foot-pound, Newton-meter or kg-cm) selected by the user via unit selector switch 66b (FIG. 1). The choice of units can be increased to cover all possible units by changing the appropriate algorithms. An electrical signal 69 for the resulting digital torque value is then sent to a liquid crystal display driver 68 and the preset torque value is displayed on liquid crystal display 54 while the user sets the desired preset torque value.

After the desired preset torque value is selected, the user presses angle mode selector button 66c to enter the angle mode of the torque wrench so that a desired preset angle value may be selected. As best seen in FIGS. 12A through 12C, an angle mode indicator 97 displays “Target Ang” when the user selects the angle mode. The user now utilizes increment/decrement buttons 65a and 65b to select the preset angle value which is displayed on numeric display 60. After the preset angle value is set, the user presses angle mode selector button 66c to place the wrench back in the torque mode and the preset torque value is once again displayed in numeric display 60.

Referring again to FIG. 9, as the user applies torque to the wrench, and thereby the fastener, once the preset torque value has been applied to the fastener and the torque wrench subsequently “trips”, as discussed in greater below, the user transitions the torque wrench from a first mode, or torque mode, to a second mode, or angle mode. As part of the shift in modes, microcontroller 102 sends an electrical signal 69 to digital display 54, causing it to display “Ang” in angle mode indicator 77 and the current accumulated angle value on numeric display 60 of the fastener as a numeric value, as shown in FIG. 12C. In the present embodiment, the user depresses angle mode selector button 66c in order to change the operating mode from the torque mode to the angle mode and switch digital display 54 from displaying the preset torque value to displaying the accumulated angle value.

When mechanical torque wrench 10 is used to measure angular rotation, gyroscopic sensor 27 senses the rotation of the mechanical torque wrench and sends an analog electrical signal 61 that varies in voltage proportionally to the rate of rotation to a gyroscopic signal conditioning unit 63 that amplifies the signal and filters it to remove noise from the signal. Gyroscope signal conditioning unit 63 outputs an amplified and conditioned analog electrical signal 65 to microcontroller 102 that converts electrical signal 65 to an equivalent angular value in degrees and adjusts for any offset of the signal. Adjusting for the offset of the signal increases the accuracy of the wrench by compensating the signal for any reading that may be present before the wrench is actually rotated. Microcontroller 102 sends an electrical signal 69, including the current accumulated angle value to digital display 54, via LCD driver circuit 68. Preferably, digital display 54 displays the current accumulated angle value in the form of both a bar graph display 71 and a numeric value display 60 during the rotation of the wrench up to a preset target accumulated angle value, as shown in FIG. 12C.

Referring additionally to FIGS. 10, microcontroller 102 converts analog electrical signal 65 to an equivalent angle value in degrees. Upon receiving analog electrical signal 65, microcontroller 102 converts analog electrical signal 65 to digital data points using an analog-to-digital converter 91. As well, microcontroller 102 adjusts electrical signal 65 for any offset of the signal. When mechanical torque wrench 10 is powered on, it is possible that gyroscopic sensor 27 will produce an electrical signal 61 even though mechanical torque wrench 10 is not being rotated. As such, microcontroller 102 determines the value of the no-load electrical signal 65 when the torque wrench is powered on and subtracts this value from all subsequent electrical signals 65 received from gyroscopic sensor 27 during torquing operations. Microcontroller 102 can adjust the received electrical signal 65 either prior to, or after, its conversion to a plurality of digital data points with the analog-to-digital converter. Since the conditions under which mechanical torque wrench 10 are used can differ, microcontroller 102 determines the magnitude of the no-load electrical signal 65 each time the mechanical torque wrench 10 is powered on and applies that value to that series of torquing operations that occur prior to powering off the mechanical torque wrench 10.

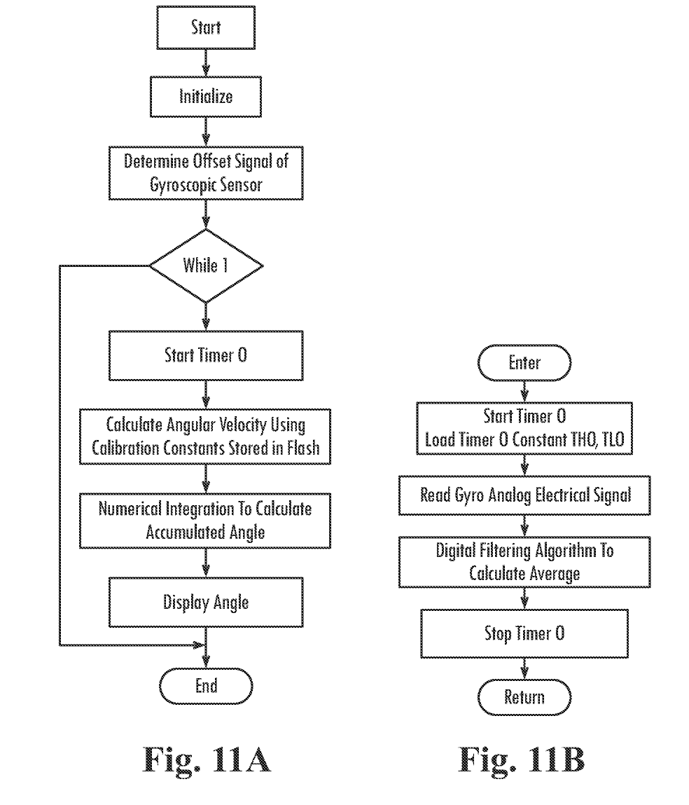

In one embodiment, microcontroller 102 utilizes a moving window digital filtering algorithm to convert the digital data points from analog-to-digital converter 91 into a plurality of equivalent digital values that it then uses to determine the accumulated angular rotation being applied with the mechanical torque wrench 10, as discussed in greater detail below. In the present example, microcontroller 102 samples one thousand digital data points per second and uses a moving sample window of 10 milliseconds. As the mechanical torque wrench rotates, microcontroller 102 averages the first ten digital data points, one taken each millisecond, thereby producing a first equivalent digital value at time t=0.01 seconds, wherein t=0.0 seconds marks the initiation of rotation of the torque wrench. At time t=0.011 seconds, microcontroller 102 averages the digital data points taken between times t=0.002 and t=0.011 seconds, thereby producing a second equivalent digital value. At time t=0.012 seconds, microcontroller 102 averages the digital data points taken between times t=0.003 seconds and t=0.012 seconds, thereby producing a third equivalent digital value. This continues such that an equivalent digital value is provided every millisecond until the mechanical torque wrench 10 is no longer being rotated. Microcontroller 102 utilizes these equivalent digital values and a numerical integration method, as discussed below with regard to FIG. 11, to determine the accumulated angle value being applied by the mechanical torque wrench 10.

FIGS. 11A and 11B are flow charts of the algorithm utilized by mechanical torque wrench 10 to determine accumulated angle values. More specifically, FIG. 11A is a flow chart of the main program of microcontroller 102, and FIG. 11B is a flow chart of an interrupt routine service program that the provides averaged values of the equivalent digital values discussed above with regard to the digital filtering algorithm. As shown, when the mechanical torque wrench 10 is powered on, the electronics configuration is initialized, and microcontroller 102 determines the offset signal of gyroscopic sensor 27, as previously discussed. Upon entering the angle mode, microcontroller 102 performs an infinite loop operation as long as the torque wrench is not powered off. Upon entering the loop, microcontroller 102 initiates a timing sequence that is related to the digital filtering algorithm discussed above. In the present embodiment, the timing sequence comprises a 10 millisecond window over which the equivalent digital values provided by the digital filtering algorithm are averaged such that an average equivalent digital value is provided for numerical integration every 10 milliseconds rather than every millisecond. For example, first average equivalent digital value of the first through tenth equivalent digital values is provided for numerical integration rather than the 10 individual values. As such, the next value provided is a second average equivalent digital value of the eleventh through twentieth equivalent digital values. At the end of each 10 millisecond window, the timing sequence interrupts the main program and provides the average equivalent digital value, which microcontroller 102 then uses to calculate the angular velocity of mechanical torque wrench 10 over that 10 millisecond window by retrieving a corresponding calibration constant that is stored in flash memory. Each calibration constant corresponds to an angular velocity value that is previously determined during the calibration of the torque wrench, as discussed below.

Microcontroller 102 performs a numerical integration with the average angular velocity values determined for each 10 millisecond period to determine the accumulated angle value through which the mechanical torque wrench is rotated, and subsequently, the fastener as well. Microcontroller 102 sends an electrical signal including the current accumulated angle value to the digital display. In the present embodiment of the torque wrench, microcontroller 102 performs the numerical integration in accordance with the equation:

$$θ = {\sum }_{i = 0}^{n} {ω}_{i} Δ t$$

where, (θ) is the accumulated angle value, (ω) is the calibration constant retrieved by the microcontroller 102 in response to receiving the (i^{th}) average equivalent digital value, and Δt is the preferred sample period of 10 milliseconds.

Note, in alternate embodiments of the mechanical torque wrench, the digital filtering algorithm does not utilize the moving window method of averaging to determine the individual equivalent digital values. Rather, the digital filtering algorithm determines an independent equivalent digital value each millisecond that corresponds to the electrical signal produced by gyroscopic sensor 27, beginning at time t=0.001. The digital filtering algorithm then averages the individual equivalent digital values over a selected window of time, that being 10 milliseconds in the present example, and provides the average equivalent digital value to microcontroller 102 for use in the previously discussed numerical integration method. In yet another alternate embodiment of the mechanical torque wrench, no averaging feature is utilized by the digital filtering algorithm in providing equivalent digital values. Rather, the digital filtering algorithm simply produces an equivalent digital value at the end of a selected window of time, that being 10 milliseconds in the present example, and provides this equivalent digital value to microcontroller 102 for use in the previously discussed numerical integration method. These embodiments may be desirable when a lesser degree of accuracy from the mechanical torque wrench is acceptable.

Preferably, after assembly, each mechanical torque wrench 10 is calibrated in order to derive the previously discussed calibration constants that are stored in flash memory. The mechanical torque wrench is rotated at a plurality of known angular velocities that would be expected to be encountered during normal operation of the mechanical torque wrench. The equivalent digital value produced at each known angular velocity is measured and recorded. A curve is fit to these data points that allows the determination of the angular rotational value, or calibration constant, for each received equivalent digital value.

Microcontroller 102 generates alarm signals in the form of audio signals and light displays of appropriate color once it is determined that the current accumulated angle value of the fastener is within a pre-selected range of the preset target accumulated angle value. As previously discussed, once the mechanical torque wrench trips at the preset torque value, the user manually switches the torque wrench and digital display 54 from the torque mode to the angle mode such that it displays accumulated angle values rather than the preset torque values.

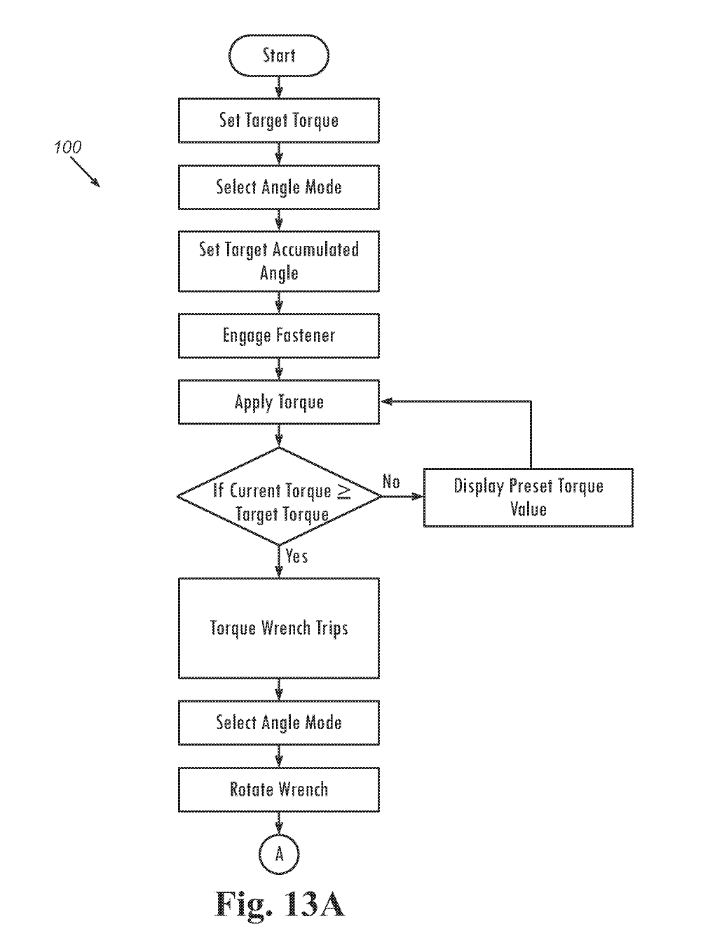

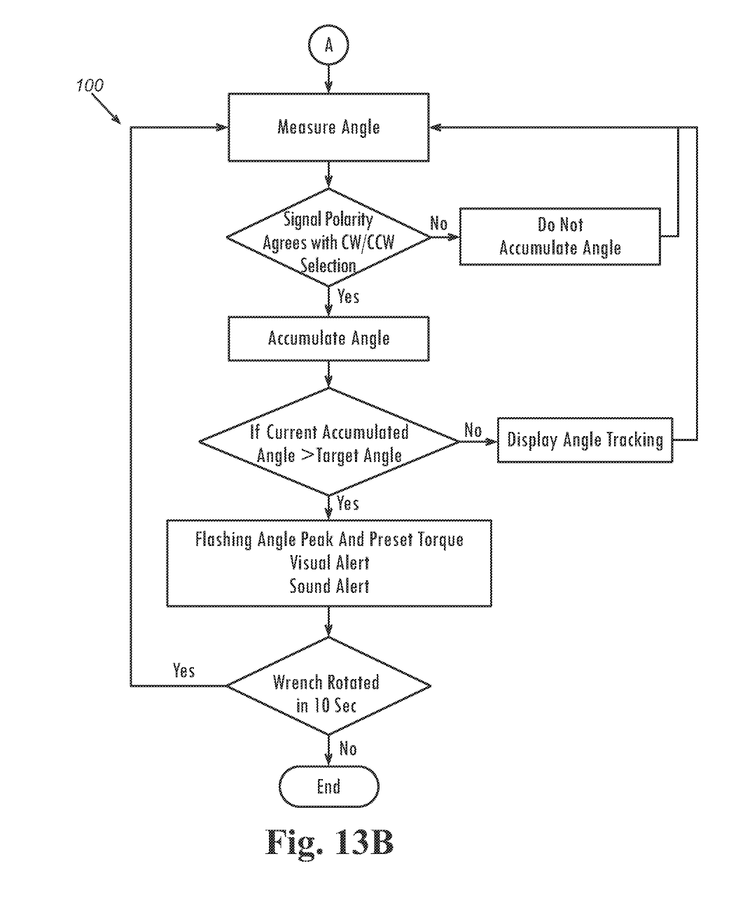

FIGS. 12A and 12B show detailed views of preferred embodiments of digital displays 54a and 54b, respectively. The LCD units include accumulated angle indicator 71, a four digit numeric display 60, an indication of units selected 62 (foot-pound, inch-pound, and Newton-meter), a torque direction indicator 93 (clockwise (CW) by default and counter-clockwise (CCW) if selected), a battery level indicator 95, an angle mode indicator 97 and an error (Err) indicator 89. As shown, accumulated angle indicator 71 is in the form of a bar graph. The bar graph is shown in two embodiments, horizontal 54a (FIG. 12A) and vertical 54b (FIG. 12B). In either case, preferably, the bar graph includes a total of ten segments 79 and a frame 81 that encompasses all ten segments 79. Frame 81 is filled by the ten segments when the preset accumulated angle value input by the user, as discussed below with regard to FIGS. 13A and 13B, is reached. At other times, frame 81 is only partially filled with segments 79, and therefore gives a graphical display of approximately how much accumulated angular rotation the fastener has undergone and how much more needs to occur. Note, prior to the user manually selecting the angle mode of the torque wrench, none of the segments will be present in frame 81, as shown in digital displays 54a and 54b.

As shown, two small arrows 83 are located on opposing sides of the eighth segment. Arrows 83 are graphical indicators to the user that accumulated angle measurement is above 75% of the preset value. Each segment 79 within frame 81 represents 10% of the preset angle value, starting from the left or bottom of each bar graph, respectively. For example, if only the first two of segments 79 are displayed, the current angle value is above 15% and below 24% of the preset angle value, and is therefore approximately 20% of the preset angle value. Simultaneously, digital display 54a/54b also displays the accumulated angle value applied up until that time in numeric display 60, as discussed in greater detail below.

Once the target preset torque value has been reached and the angle mode of the torque wrench is entered by the user depressing angle mode selector button 66c, numeric display 60 displays the accumulated angular rotation of the torque wrench, rather than the preset target torque value, and angle mode indicator 97 shows “Ang” to indicate the wrench is in the angle mode, as best seen in FIG. 12C. When continuing to rotate the fastener, the user may, rather than focusing on four digit numeric display 60, view the bar graph of current accumulated angle indicator 71 until the applied accumulated angle value reaches approximately 75% to 80% of the preset target accumulated angle value, depending on the user's comfort level when approaching the preset value. At this point, the user may change focus to numeric display 60 for a precise indication of the current accumulated angle through which the fastener has been rotated as the preset target value is approached. Numeric display 60 shows the accumulated angle value to which the fastener has been subjected. As such, if the user has “backed off” during the application of rotation, such as during ratcheting operations, the value indicated on numeric display 60 will not change until the mechanical torque wrench senses further rotation of the fastener. Display device 54c allows the user to know both how much rotation the fastener has undergone and how much more rotation needs to occur before reaching the target preset accumulated angle value.

FIGS. 13A and 13B illustrate a flow chart 100 of the algorithm used with the electronics unit. Prior to initiating torquing operations, the input device is used to set a preset target torque value into the mechanical torque wrench that equals the maximum desired torque to be applied to the fastener during the torquing mode. As well, after inputting the preset target torque value, the user selects the target angle mode, as discussed above, and inputs a preset target accumulated angle value into the mechanical torque wrench that equals the maximum desired angular rotation to be applied to the fastener subsequent to reaching the preset target torque value. After the preset target accumulated angle value is entered, the user presses angle mode selector button 66c and the mechanical torque wrench reverts to the torquing mode, and digital display 54 displays the preset target torque value in numeric display 60 (FIGS. 12A and 12B).

Referring additionally to FIG. 9, as torque is applied, microcontroller 102 (for example, Model No. ADuC843 manufactured by Analog Devices, Inc.) continues to receive and read a signal conditioned analog electrical signal 64 from resistive element signal conditioning circuit 62, convert the analog electrical signal to an equivalent digital number, convert the digital number to an equivalent preset torque value corresponding to the user selected units, send electrical signal commands 69 to LCD driver circuit 68 (Model No. HT1621 manufactured by Holtek Semiconductors, Inc., Taipei, Taiwan) to generate appropriate signals to digital display unit 54 for displaying the preset torque value in numeric display 60.

The amount of torque applied to the fastener increases until clicker mechanism 26 (FIG. 2) trips such that bar 20 pivots relative to wrench body 14, thereby striking the wrench body, as previously discussed. Once the preset torque value is reached, the user enters the angle mode by pressing angle mode selector button 66c. As shown in FIG. 10, as the user begins to rotate the mechanical torque wrench, microcontroller 102 receives and reads a signal conditioned analog electrical signal 61 (as previously discussed with regard to FIG. 9) from gyroscopic sensor 27, converts the analog electrical signal to an equivalent digital number, and converts the digital number to an equivalent current angle value. Simultaneously, microcontroller 102 determines whether the signal conditioned analog signal from gyroscopic sensor 27 is positive (+) or negative (−) in order to determine whether or not to measure and accumulate angular rotation. More specifically, gyroscopic sensor 27 generates either a positive or negative signal based on the direction of rotation (either CW or CCW) of the torque wrench. As such, dependent upon whether the user has selected to apply torque in the CW or CCW direction, microcontroller 102 can determine when torque is being applied to the fastener and thereby accumulate angular rotation, or determine that only ratcheting is occurring and not accumulate angular rotation.

Microcontroller 102 also determines whether the current accumulated angle value is equal to or greater than the preset target accumulated angle value. If the current accumulated angle value has not yet reached the target value, microcontroller 102 sends electrical signal commands 69 to LCD driver circuit 68 to generate appropriate signals to digital display unit for updating the number of segments 79 shown in current accumulated angle indicator 71 and the current accumulated angle value shown in numeric display 60.

As well, microcontroller 102 switches green 56a, yellow 56b, and red 56c LEDs on or off depending on the current accumulated angle value applied to the fastener up until that time. Preferably, microcontroller 102 maintains green LED 56a on as long as the current accumulated angle value is below 85% of the preset target accumulated angle value and switches it off once the current accumulated angle reaches 85% of the preset target accumulated angle value. Microcontroller 102 switches yellow LED 56b on for current accumulated angle values greater than 85% but less than 96% of the preset target accumulated angle value. Microcontroller 102 switches red LED 56c on once the current accumulated angle value reaches 96% of the preset target accumulated angle value and stays on thereafter. Once the current torque value reaches the preset target accumulated angle value, or is within a user selected range, microcontroller 102 generates electrical signals to generate an alarm sound on annunciator 47. At this point, the user ceases to rotate the mechanical torque wrench, and numeric display 60 alternately flashes both the preset torque value and the final accumulated angle value to which the fastener was subjected. Note, however, it may be possible to achieve the preset target accumulated angle value without having to use the ratcheting feature of the mechanical torque wrench, i.e., the desired rotation of the fastener is achieved with a single rotational stroke of the torque wrench. In many applications, the fastener will need to be rotated by using multiple ratcheting cycles. The selection of percentage ranges for each color may be programmed, and the percentages at which the LEDs are switched on or off can be changed to suit the specific application.

The torque wrench continues to accumulate angle either until the wrench is powered off or until the user depresses the angle mode selector button 66c twice in rapid succession (thereby ending the while loop indicated in FIG. 11A). Thus, the wrench may be considered to accumulate angle during a period that is predetermined by those conditions.

The algorithm also keeps track of the activity of the torque wrench. If the wrench is inactive for a predetermined period of time, the electronics unit shuts off the power to save battery life. Preferably, a predetermined period of three minutes is used. Regardless of whether the unit is switched off by manually pressing the power button or due to an inactivity-triggered auto shutoff, the microcontroller saves the unit selected in non-volatile memory (flash memory in the preferred embodiments). This feature allows the electronic unit to come on and display the last preset torque value and selected unit.

The embodiments of the mechanisms for converting the mechanical rotary dialing motion into an equivalent electrical signal described herein are for illustration purposes only. It is envisioned that other embodiments may also use optical, magnetic, or capacitance based mechanisms as position sensors for the dial screw rather than the resistance-based mechanism discussed above. For example, magnetic sensors such as magnetostriction rods with ring wipers can be used. Similarly, optical scales and laser diode readers can be used, as can capacitance sensors having two sliding grid patterns with one stationary and the other movable to change the capacitance. Furthermore, the mechanical rotary motion of a thumb wheel used in split beam type mechanical torque wrenches falls within the scope of this invention. No matter what mechanism is used to generate the rotary motion, the methodology needed to convert the rotary motion to an equivalent electrical signal does not change from what is described in this invention. These and other like mechanisms that can be used to convert a mechanical rotary motion into an equivalent electrical signal are within the scope of this invention.

While one or more preferred embodiments of the invention are described above, it should be appreciated by those skilled in the art that various modifications and variations can be made in the present invention without departing from the scope and spirit thereof. It is intended that the present invention cover such modifications and variations as come within the scope and spirit of the appended claims and their equivalents.

What is claimed is:

1. A mechanical torque wrench for engaging a workpiece, comprising:
a wrench body defining an elongated interior compartment;
a wrench head including a workpiece engaging portion and a bar extending therefrom, the wrench head being pivotably secured to a first end of the wrench body at a pivot joint, the bar extending into the interior compartment and the workpiece engaging portion extending outwardly from the wrench body;
a set spring disposed within the interior compartment of the wrench body;
a block disposed between a rear face of the bar and the set spring;
a dial screw threadably received within the interior compartment of the wrench body such that the dial screw moves along a longitudinal axis of the wrench body when rotated, rotation of the dial screw in a first direction compressing the set spring and rotation in a second direction allowing expansion of the set spring;
a resistive element operatively coupled to the dial screw and producing an output signal, the output signal being dependent on a position of the dial screw relative to the resistive element;
a first sensor operatively coupled to the wrench body and producing a first output signal, the first output signal being proportional to an amount of angular rotation being applied to the workpiece by the torque wrench during a first rotational cycle of the mechanical torque wrench;
a processor for converting the output signal into an equivalent torque value, the equivalent torque value indicating a preset torque to be applied by the mechanical torque wrench to the workpiece, and converting the first output signal into a first angle value through which the workpiece has been rotated; and
a user interface including a display for displaying the equivalent torque value,
wherein application of a torque greater than the preset torque to the workpiece causes the wrench head to pivot relative to the wrench body about the pivot joint.

2. The mechanical torque wrench of claim 1, further comprising a hand grip located on a second end of the wrench body, and a set ring positioned adjacent the hand grip, the set ring being operatively connected to the dial screw and rotatable relative to the wrench body.

3. The mechanical torque wrench of claim 2, the resistive element further comprising a potentiometer fixed to the interior compartment of the wrench body.

4. The mechanical torque wrench of claim 3, the potentiometer further comprising a sliding potentiometer including a resistor and a wiper assembly, wherein movement of the dial screw along the longitudinal axis of the wrench body similarly moves the wiper assembly along the resistor such that the output signal is altered.

5. The mechanical torque wrench of claim 1, further comprising a ratchet mechanism so that torque can be applied to the workpiece using multiple rotational cycles of the electronic torque wrench without having to disengage the workpiece.

6. The mechanical torque wrench of claim 5, wherein the processor determines the first angle value during the first rotational cycle, and converts a second output signal produced by the first sensor during a second rotational cycle into a second angle value through which the workpiece has been rotated.

7. The mechanical torque wrench of claim 6, wherein the processor adds the first angle value and the second angle value to determine an accumulated angle value.

8. The mechanical torque wrench of claim 1, the first sensor further comprising a gyroscopic sensor for indicating the amount of angular rotation applied to the workpiece.

9. A mechanical torque wrench for engaging a workpiece comprising:
a wrench body defining an elongated interior compartment;
a wrench head pivotably received in the interior compartment, the wrench head including a drive portion for engaging the workpiece and a bar extending into the interior compartment;
a set spring disposed within the interior compartment of the wrench body;
a dial screw rotatably received within the interior compartment of the wrench body, rotation of the dial screw in a first direction increasing force exerted on the set spring and rotation of the dial screw in a second direction decreasing force exerted on the set spring by the dial screw;
a gyroscopic sensor operatively coupled to the wrench body and producing a first output signal, the first output signal being proportional to an amount of angular rotation being applied to the workpiece by the torque wrench;
a processor for converting the first output signal into a first angle value through which the workpiece has been rotated during a first rotational cycle of the torque wrench; and
a user interface including a display for displaying the first angle value,
wherein application of a torque greater than a preset torque value to the workpiece causes the wrench head to pivot relative to the wrench body.

10. The mechanical torque wrench of claim 9, further comprising a resistive element including a resistor and a wiper assembly, the wiper assembly being operatively coupled to the dial screw, the resistive element producing an output signal that is related to a position of the dial screw relative to the resistive element.

11. The mechanical torque wrench of claim 10, wherein the output signal of the resistive element is proportional to the preset torque value.

12. The mechanical torque wrench of claim 9, further comprising a ratcheting mechanism so that torque can be applied to the workpiece using multiple rotational cycles of the torque wrench.

13. The mechanical torque wrench of claim 12, wherein the processor converts a second output signal of a second rotational cycle into a second angle value through which the workpiece has been rotated during second rotational cycle.

14. The mechanical torque wrench of claim 13, wherein the processor adds the first angle value and the second angle value to determine an accumulated angle value.
